(19) United States
(12) Patent Application Publication
(10) Pub. No.: US 2024/0346580 A1
(43) Pub. Date: Oct. 17, 2024

(54) AUTOMATIC GENERATION OF CODE FOR ATTRIBUTES

(71) Applicant: Experian Information Solutions, Inc., Costa Mesa, CA (US)

(72) Inventors: Hua Hu, Irvine, CA (US); Luz M. Torrez, Fountain Valley, CA (US)

(21) Appl. No.: 18/502,317

(22) Filed: Nov. 6, 2023

Related U.S. Application Data
(63) Continuation of application No. 17/443,986, filed on Jul. 29, 2021, now Pat. No. 11,847,693.
Application No. 17/443,986 is a continuation of application No. 16/356,979, filed on Mar. 18, 2019, now Pat. No. 11,107,158.
Application No. 16/356,979 is a continuation of application No. 14/618,869, filed on Feb. 10, 2015, now Pat. No. 10,262,362.
(60) Provisional application No. 61/940,043, filed on Feb. 14, 2014.

(51) Int. Cl. G06Q 40/03; G06F 8/41

(52) U.S. Cl. CPC G06Q 40/03; G06F 8/427

(57) ABSTRACT

One embodiment of a system for automatically generating code for attributes includes a credit bureau data store that stores credit bureau convention information and an attribute generation system that communicates with the credit data store to detect rules associated with respective credit bureaus. The system may include an input module which receives, from a user system, a document comprising pseudo-code defining attributes including credit bureau specific logic; an error checking module which automatically performs error checking and provides error correcting information on the document; an attribute verification module which parses the document to identify attributes and automatically retrieves rules associated with the respective credit bureaus; a document generation module which generates an attribute specification document based on the retrieved rules as applied to the attributes in the document; and a code generation module which generates an executable code set based on the retrieved plurality of attributes and credit bureau specific rules.

### CROSS-REFERENCE TO RELATED APPLICATIONS

This application is a continuation of U.S. patent application Ser. No. 17/443,986, filed on Jul. 29, 2021, and titled “Automatic Generation of Code for Attributes,” which is a continuation of U.S. patent application Ser. No. 16/356,979, filed on Mar. 18, 2019, titled “Automatic Generation of Code for Attributes,” and issued as U.S. Pat. No. 11,107,158, which is a continuation of U.S. patent application Ser. No. 14/618,869, filed on Feb. 10, 2015, titled “Automatic Generation of Code for Attributes,” and issued as U.S. Pat. No. 10,262,362, which claims the benefit of priority from U.S. Provisional Patent Application No. 61/940,043 filed on Feb. 14, 2014, titled “Systems and Methods of Automated Attribute Generation.” The entire contents of the above-referenced applications are hereby expressly incorporated herein by reference in their entireties. All publications and patent applications mentioned in this specification are herein incorporated by reference in their entireties to the same extent as if each individual publication or patent application was specifically and individually indicated to be incorporated by reference.

### BACKGROUND OF THE DISCLOSURE

Many companies have a significant interest in obtaining information that indicates the relative financial risk or profitability of potential business transactions with individuals or other entities. For example, a lending institution may be interested in the relative likelihood that a loan recipient will timely and reliably make the agreed-upon loan payments. An insurance company may be interested in the relative likelihood that an existing or potential client may file certain claims. Such predictive information can be used to decide whether a company should engage in a particular business transaction and/or the terms that should be used for the transaction.

A large variety of public records and privately developed databases can be utilized to inform such risk/benefit determinations. For example, credit reporting agencies (CRAs) collect and maintain information about a person's individual credit history and the person's accounts. This information can include, for example, total credit line for each account, current credit balance for each account, credit ratios, whether an account is in good standing, whether there have been delinquent payments on an account, the date when an account was opened, records of recent and/or historical inquiries into the person's credit, and so forth. Such information is also available for groups of individuals as well as entities. However, the extensive amount of data available for any given person or entity makes the task of evaluating a business decision based purely on raw credit data very difficult.

### SUMMARY OF CERTAIN EMBODIMENTS

Embodiments of systems and methods for automatic attribute generation are disclosed herein.

One embodiment is a system for automated credit attribute specification and code set generation including a credit bureau data store and an attribute specification and code set generation server. The credit bureau data store is configured to store credit bureau convention information for a plurality of credit bureaus. The attribute specification and code set generation server is configured to communicate with the credit data store to access credit bureau convention information in order to detect rules associated with the respective credit bureaus. The attribute specification and code set generation server includes: an input module, an error checking module, an attribute verification module, a document generation module and a code generation module. The input module is configured to receive a document from a user system, the document comprising pseudo-code defining a plurality of attributes including credit bureau specific logic. The error checking module is configured to automatically perform error checking and provide error correcting information on the document received. The attribute verification module is configured to parse the received document to identify attribute and automatically retrieve rules associated with the respective credit bureaus from the credit bureau data store. The document generation module is configured to generate an attribute specification document based on the retrieved rules as applied to the plurality of attributes in the received document. The code generation module is configured to generate at least one executable code set based on the retrieved plurality of attributes and credit bureau specific rules. The attribute specification and code set generation server may also include a driver module configured to validate input information in the document received and a transformation module configured to translate the attribute specification document into a set of standardized code.

Another embodiment is a computer-implemented method for automated credit attribute specification and code set generation, the method including, as implemented by one or more computing devices configured with specific computer-executable instructions, storing credit bureau information for a plurality of credit bureaus credit, the credit bureau information comprising rules associated with attributes at the respective credit bureaus, receiving a document from a user system, the document comprising pseudo-code defining a plurality of attributes, automatically performing error checking and providing error correcting information on the document received, parsing the received document to identify attributes, automatically retrieving rules associated with attributes at the respective credit bureaus from the credit bureau data store, generating an attribute specification document based on the retrieved rules as applied to the plurality of attributes in the received document, and generating at least one executable code set based on the retrieved plurality of attributes and credit bureau specific rules.

Another embodiment is non-transitory computer readable storage media storing computer-executable instructions that, when executed by a computer system, configure the computer system to perform operations including: storing credit bureau information for a plurality of credit bureaus credit, the credit bureau information comprising rules associated with attributes at the respective credit bureaus, receiving a document from a user system, the document comprising pseudo-code defining a plurality of attributes, automatically perform error checking and provide error correcting information on the document received, parsing the received document to identify attributes, automatically retrieving rules associated with attributes at the respective credit bureaus from the credit bureau data store, generating an attribute specification document based on the retrieved rules as applied to the plurality of attributes in the received document, and generating at least one executable code set based on the retrieved plurality of attributes and credit bureau specific rules.

### BRIEF DESCRIPTION OF THE DRAWINGS

FIG. 1 is one embodiment of a block diagram of a computing environment for automatically generating credit attribute specifications and/or code sets.

FIG. 2 is one embodiment of a flow diagram of an illustrative method for automatically generating credit attribute specifications and/or code sets.

FIG. 3 is one embodiment of a flow diagram of an illustrative method for performing error checking and providing error correcting information.

FIG. 4 is one embodiment of a flow diagram of an illustrative method for performing attribute verification.

FIG. 5 is one embodiment of a sample specification illustrating an example of an automatically generated specification for an attribute.

FIG. 6 is one embodiment of a sample code illustrating an example code set generated.

FIG. 7 is one embodiment of a block diagram of a computing system for automatically generating credit attribute specifications and/or code sets.

### DETAILED DESCRIPTION OF EMBODIMENTS

The terminology used in the description presented herein is not intended to be interpreted in any limited or restrictive manner, simply because it is being utilized in conjunction with a detailed description of certain specific embodiments. Furthermore, embodiments may include several novel features, no single one of which is solely responsible for its desirable attributes or which is essential to practicing the systems and methods described herein.

While there is a vast amount of credit data available for each individual and entity, attributes can be used to sift through that data and identify essential elements of credit data that can be used for a particular risk analysis or for marketing purposes, including, for example, for segmenting populations for more accurate targeting, for determining new acquisitions, and the like. The attributes can also provide calculations and analysis on the selected data to generate a score or other indication of risk to help guide business decisions. For example, a person's raw credit data can be processed to generate a “score” indicative of his or her relative credit worthiness. Such a score can then be utilized by a company to decide whether to extend the person further credit or what interest rate to apply to the person's credit card account. The company may be a credit card company, a financial institution, a bank, a retail company, a car sales company, a healthcare company, a merchant, a service provider, a non-profit group, other corporate entities, or the like. The evaluation of the relative risk/benefit of a given decision is even more complex when considering multiple persons simultaneously, such as spouses, partnerships, sole proprietorships, joint ventures, or corporate families. In such cases, raw data from multiple sources about each of the individuals or the entities may need to be evaluated.

Attributes can be designed to reference various aspects of credit history data, bankruptcy data, and other types of credit-based data. For example, one simple attribute could be “consumers with active credit card accounts that are 30 days past due.” When applied to credit data for a set of consumers, the results would indicate which consumers meet both the criteria of (1) having active credit cards and (2) being 30 days past due on the active credit cards. As another example, an attribute could be “total number of credit cards with balances over $500.” When applied to credit data for a set of businesses, the results would be a listing of the businesses showing the total number of credit cards that have balances over $500 for each business. It is recognized that a wide variety of attributes may be created for use with credit data. In addition, the complexity of the attributes may range from simple to very complex, with some attributes referencing hundreds of other attributes and utilizing hundreds of different items of credit data. As such, attributes are crucial in facilitating the use of credit data to assist financial institutions and other entities in making their business decisions. It is also recognized that attributes can be developed for use with non-credit data sources in addition to, or instead of, credit data sources.

Accordingly, a company may wish to create attributes that identify particular features of a set of consumers or entities. While the company may have a general idea of how to define the attribute, the actual coding of the attribute into specific sets of computer-readable code can be difficult, time consuming, and prone to errors. In addition, the company may need to deploy its attributes on different systems, each of which have their own specific requirements and use different programming languages. Thus, embodiments of an automated attribute generation system are disclosed herein that allow for the automatic generation of attribute specification documents and/or platform-specific code sets.

In some embodiments, the automated attribute generation system includes modules for input, error checking, input validation, attribute verification, document generation, and standardized and customized code generation. The input module receives, from a user system, a document comprising pseudo-code defining attributes with credit bureau specific or other logic specific to the data source, thereby reducing the processing steps required to parse the document and increasing the processing speed. The error checking module automatically performs error checking and provides error correcting information on the document, thereby providing a reduced error rate for the document and consequently enhancing the reliability of the document. The attribute verification module parses the document to identify attributes and automatically retrieves rules associated with the respective credit bureaus. The document generation module generates an attribute specification document based on the retrieved rules as applied to the attributes in the document. The code generation module generates an executable code set based on the retrieved attributes and credit bureau specific rules, resulting in simplified software development and in improved usability of the attribute specification document.

An attribute may perform actions or calculations on raw data, filtered data, as well as other attributes. In some embodiments, a “filtering attribute” or “filter” refers to an attribute that only performs actions or calculations on raw data. One example filter may be “all open credit card accounts” which would filter out or exclude all closed accounts and all open non-credit card accounts from a set of credit data. However, other filters may perform actions or calculations on filtered data, other attributes, or other data. It is recognized that a filter is one of many types of attributes.

The terms “individual” and “customers,” and “consumers” as used herein, should be interpreted to include applicants, customers, single individuals as well as groups of individuals, such as, for example, families, married couples or domestic partners, and business entities.

### EXAMPLE

As one example, a credit card company may want to determine information about its potential applicants as well as its current credit holders. The credit card company may employ different systems to screen potential applicants and to manage current credit holders. Specifically, the new accounts side of the company may wish to determine, for example, information regarding applicants' past credit profiles, in order to determine whether to extend an offer, and if so, what credit limit to set based on past payment history. The customer relations side of the company may wish to monitor its current credit holders to, detect fraudulent transactions and to determine patterns of purchases. Given the different systems employed by the company, and given the different goals, the company not only has a need for different attributes, but also needs different specifications and code sets for its different systems.

Thus, the company may create a spreadsheet with pseudo-code for a first set of attributes to help the company detect fraudulent activity and a second set of attributes to help the company select potential applicants that will receive offers and decide on an appropriate credit limit for each applicant. The company may then provide the spreadsheet to the automated attribute generation system and indicate that it needs the attributes to be deployed on a Fascode system as well as on an SAS system. The system can then generate an attribute specification document for both sets of attributes which will assist the company's users in utilizing the attributes as well as Fascode and SAS code for both sets of attributes which can be run on the appropriate company systems. The automated generation of the document, performed with increased processing speed and reduced error rate than the manual generation of the same document, provides the company with a more reliable and usable document with a reduced error rate in the processing.

### Benefits of Various Embodiments

Embodiments of the automated attribute generation system may provide one or more of the following benefits. First, the automated attribute generation system leaves less room for the subjective interpretation of the meaning of the attributes, providing less room for errors. Second, the automated attribute generation system may improve logical accuracy such that less time is spent coding allowing for more time for analyzing and auditing, providing increased processing speed. Third, the automated attribute generation system may improve coding accuracy and allow the specifications and code to be synchronized, resulting in enhanced reliability. Fourth, the automated attribute generation system may reduce the need for re-coding of attributes, also aiding in increased processing speed. Fifth, the automated attribute generation system may shorten the development timeline allowing the attributes to be deployed more quickly through the simplified software development and increased processing speed. Sixth, the automated attribute generation system may provide for increased portability and consistency such that code can be generated for multiple platforms where the code performs the same functionality. It also reduces the time to migrate from one platform to another.

### Attribute Generation System

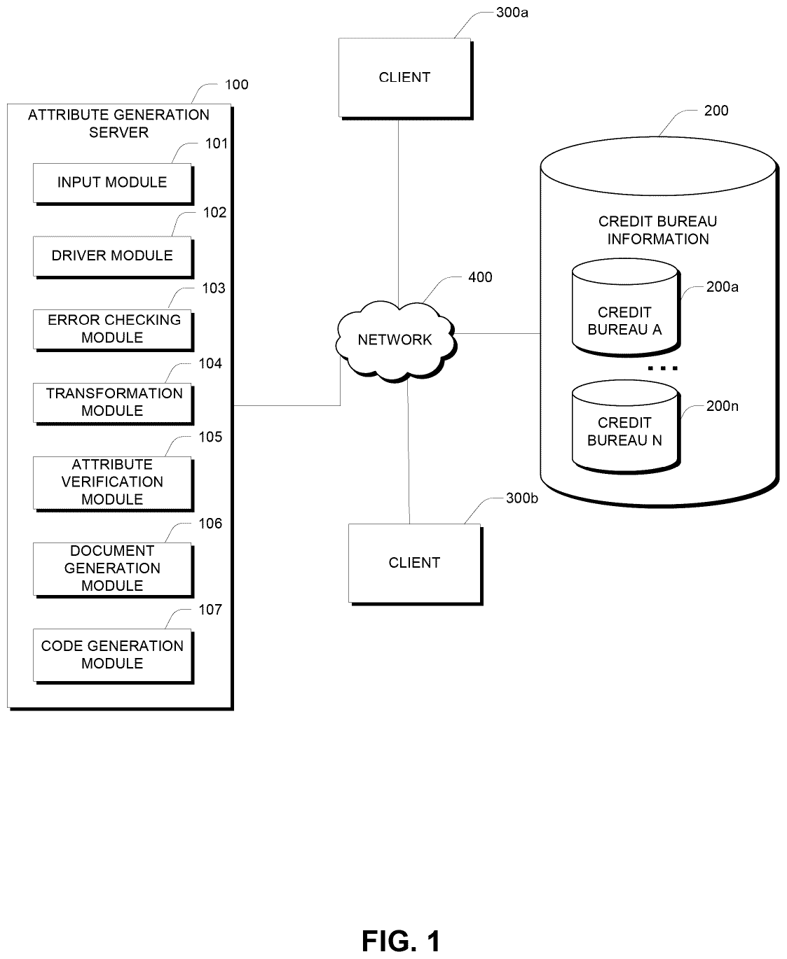

FIG. 1 is a block diagram showing an embodiment in which attribute generation system 100 (which may also be referred to herein as computing system 100) is in communication with a network 400 and configured to provide automated attribute generation.

For example, the computing system 100 may be configured to automatically generate attribute specifications and/or code sets. In some embodiments, as described in more detail below, the attribute generation system 100 may receive a document describing one or more attributes, perform error correction on the document, verify the described attributes based on CRAs' specific conventions and generate a specification document and/or a code set related to the described attributes. In some embodiments, the computing system 100 is accessed remotely by one or more clients 300a, 300b, the system is local to the client 300a or 300b, and/or a combination of the two.

In the embodiment of FIG. 1, the computing system 100 includes an input module 101, a driver module 102, an error checking module 103, a transformation module 104, an attribute verification module 105, a document generation module 106, and a code generation module 107. The computing system 100 is configured to execute the various modules 101, 102, 103, 104, 105, 106 and 107, among others, in order to receive a document describing various attributes in pseudo-code, perform error checking and validation on the document and then automatically generate a specification and/or a code set for the attributes.

In the embodiment of FIG. 1, the computing system 100 is electronically coupled to a network 400, which comprises one or more of a LAN, WAN, the Internet, or cloud computing, for example, via a wired, wireless, or combination of wired and wireless, communication link. The network 400 communicates with various computing devices and/or other electronic devices via wired or wireless communication links and may also communicate with other systems in addition to the computing system 100.

Referring to FIG. 1, in addition to the devices and systems that are illustrated in FIG. 1, the network 400 may communicate with other data sources or other computing devices. In addition, the data sources may include one or more internal and/or external data sources. In some embodiments, one or more of the databases or data sources may be implemented using a relational database, such as Sybase, Oracle, CodeBase and Microsoft® SQL Server as well as other types of databases such as, for example, a flat file database, an entity-relationship database, and object-oriented database, and/or a record-based database. In addition to supplying data, a client 300 may request information from the computing system 100.

As shown in FIG. 1, information may be provided to computing system 100 over the network 400 from one or more data sources including, for example, credit bureau database 200, which itself includes one or more databases 200a . . . 200n associated with credit bureaus A . . . N, also referred to herein as CRAs. It is noted that in other embodiments one or more of the credit bureau databases 200a . . . 200n may be located remotely and run separate from the credit bureau database 200. The credit bureau database 200 may include information on which credit attribute information items are available from a particular credit bureau and may also include information relating to conventions used for each particular credit bureau or database. For example, the conventions may include various naming conventions specifying details of upper or lower case format for names, letters, numbers or other special characters used in names and/or rules for logical words used (for example, only lower case for logic key words). The conventions may also include example of input fields expected and conventions for standardized specifications. As one example, CRA “ABC” may require that all data field names are in upper case format and that the “*” is a wildcard, whereas CRA “XYZ” may not care whether data field names are in upper or lower case, and may use “?” as a wildcard symbol. In addition, the credit bureau database 200 may also include credit data for a set of consumers and/or businesses.

### Attribute Generation Methods

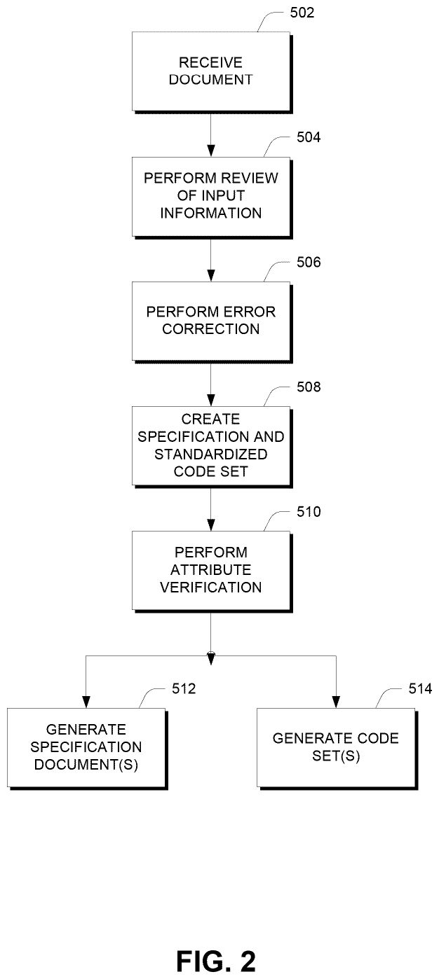

FIGS. 2-4 will be used to describe example methods implemented by embodiments of an automated attribute generation system 100 that provides specifications and code sets to entities, including, for example, the credit card company in the example above. The methods may also be used by a credit bureau or credit reporting agency (CRA) to develop automated specifications and code sets for its own attributes, which may also need to run on different platforms.

### Attribute Generation

FIG. 2 is one embodiment of a flow diagram of an illustrative method for automatically generating credit attribute specifications and code sets. The method may be implemented by a system such as the attribute generation system 100. For ease of description, the blocks are described in the order shown in FIG. 2, but it is recognized that the blocks may be performed in an order different than the one illustrated. At block 502, the system receives a document from a client that includes pseudo-code associated with a set of attributes. In some embodiments, the document is received electronically. In some embodiments, the document is received by other means. The document may be in the form of a spreadsheet document, a text file, an electronic document, a data stream, an email, or the like. In some embodiments, each of the attributes in the document is associated with one or more CRAs.

Optionally, the system 100 may also receive information from the client about the target platform(s) (not shown). This information may be received each time a document is received, it may be received the first time a document is received for a particular client, and/or it may be entered into the system 100 separate from the document, such as, when the client's account is initially set up. For example, one of the client's platforms may be a C code environment, while the other may be in SAS code. Other example platforms may include one or more of LUA code, EDL code or Fascode.

After the document is received, then, at block 504, the driver module 102 of the system 100 may perform a review of input information. For example, the driver module 102 can connect an input module to a specific credit-based data source. The driver module 102 can also set up the appropriate data source layout, formats, standard names, bureau-specific verifications, and the like. The driver module 102 performs the input field transformations on the document received by the input module depending on the data source. The driver module 102 may also connect the error checking module to a specific credit-based data source, and validate if the input information is correctly used in the system 100. This error checking helps in the reduction of error rates. When data source structures are added or updated, the driver module 102 of the system 100 may also be added or updated as necessary, such as if a data-specific driver does not exist. In such case, a new driver can be created and added into the driver stores. In some embodiments, the document received at block 502 may be directly processed for error correction at block 506 without the use of a driver module at block 504.

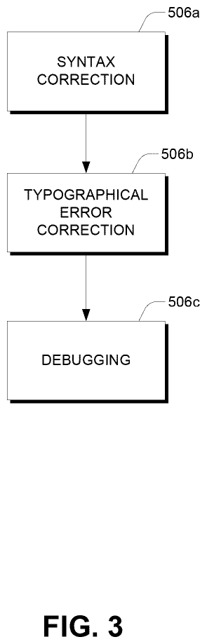

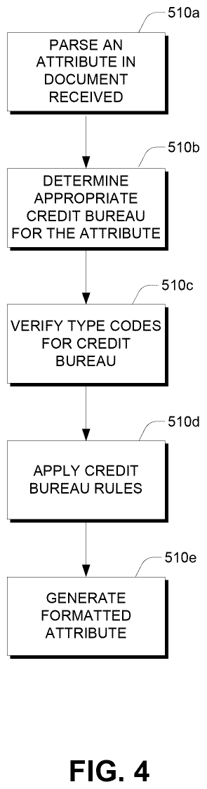

Next, at block 506, the system 100 performs error correction on the document. One embodiment of an error correction method is illustrated in FIG. 3, and is described below. After error correction, at block 508, the transformation module 104 of the system 100 uses pattern search functions to allow the specifications to be written using more readable pseudo-code conventions. This transformation into more readable conventions improves the usability of the document. After error checking and error correcting, the transformation module 104 may translate the specifications into a set of standardized code. The transformation module 104 may also provide a set of standardized code to the attribute verification module. Specific computer language code can then be derived from this set of standardized code such that different computer languages could be derived from this same set of standardized code. This standardized code is thus helpful in providing simplified software development and ensures less processing steps when deriving code in different languages. Then, at block 510, the system 100 performs attribute verification on the corrected document. One embodiment of an attribute verification method is illustrated in FIG. 4, and is described below. After the error correction and attribute verification are performed, the system 100 generates one or more specification documents at block 512 and/or code sets at block 514. The specification documents and/or code sets generated may be generic, or may be formatted to be platform-specific, based on information received from the client, set by the client, or determined by the system 100.

Using the example above, the credit card company may upload a spreadsheet to the attribute generation system 100, where the spreadsheet specifies pseudo-code for attributes that the company would like to use to determine past credit profiles and payment histories for a first list of entities potential (applicants), and to determine potentially fraudulent transactions and purchase trends for a second list of entities (current card holders). The system 100 may also receive information stating that the credit card company wants the first X attributes to run on platforms 1, 2, and 3, and the remaining attributes to run on platforms 2 and 4. The system 100 then performs error correction on the pseudo-code automatically checking errors, verifies the attributes, and then generates specifications for all of the attributes and three sets of code for the first X attributes for platforms 1, 2, and 3 and two sets of code for the remaining attributes for platforms 2 and 4.

### Error Correction

FIG. 3 is one embodiment of a flow diagram of an illustrative method for performing error correction. The error correction results in significantly reduced error rate and enhanced reliability of the document. As described above, the document received from the client at block 502 of FIG. 2 may be a spreadsheet document or a text document, and at block 504, the document's fields may be transformed depending on the data source. The document may include pseudo-code for one or more attributes in the format of one or more of the templates. In some embodiments, the document may have been written by an individual or entity with limited or no knowledge of specific programming languages or specific platform constraints.

At block 506a, the system 100 may perform syntax checking and correction on the pseudo-code. The syntax checking and correction may be performed using information from one or more of the credit bureau-specific databases 200a . . . 200n illustrated in FIG. 1. For example, syntax checking and correction may include verification of credit-bureau specific data formats associated with different credit bureaus. Syntax checking and correction may further include verification of the various bureau-specific conventions, including logical and naming conventions. Syntax checking and correction may also include verification of various values for input and output fields. In some embodiments, syntax checking may be performed using Java Script, though it is recognized that other applications, protocols, and languages may be used.

At block 506b, the system 100 may also perform basic typographical error correction. Such error correction could be configured to require or not require the use of credit-bureau specific information. Typographical error correction corrects errors often introduced via manual entry of information into the received document, including spelling errors and the like.

At block 506c, the system 100 may also perform debugging using the document received. As described above, the document received from the client may be in pseudo-code. The pseudo-code may include many errors preventing the document from being run as executable code. Therefore, at block 506c, debugging is performed to detect such errors.

It is recognized that error correction at block 506 of FIG. 2 may include one or more of blocks 506a, 506b, or 506c illustrated in FIG. 3. In various embodiments, one or more of blocks 506a, 506b and/or 506c may be performed in parallel or in an order different than that illustrated in FIG. 3.

### Attribute Verification

FIG. 4 is one embodiment of a flow diagram of an illustrative method for performing attribute verification. One main difficulty with attribute and filter development is the significant effort required for validating attributes. Often attribute and filter developers have to test the attributes and filters on sample data and modify them repeatedly to improve performance and accuracy. In addition to this iterative process, developers have to account for the large number of dependencies that can potentially be in any attributes and filters. Attributes may depend upon other attributes and may further depend on filters, which in turn are dependent on the raw data definitions. This is because in some embodiments, attributes are data-independent and filters are data dependent. In one embodiment, each filter is tied to a particular data source or set of data sources. Each filter can also reference other filters, functions, and data definitions. Each attribute, in turn, can reference a number of filters, functions, and other attributes. Thus, an error in a data definition in a single filter can adversely affect all filters that reference that single filter, and in turn all attributes that reference those affected filters will be adversely affected as well.

In some embodiments, validating an attribute may include dependency tracing. In one example, an attribute A may reference three other attributes B, C, D, and attributes B, C and D may each reference three filters B1, B2, and B3, C1, C2, and C3, and D1, D2, and D3, respectively. Validating an attribute A may include applying filters B1, B2, B3, C1, C2, C3, D1, D2, and D3, as well as the results of calculating the values for attributes B. C, and D. Therefore, by allowing for automated validation, the system provides increased processing speed, reduced error rate and enhanced reliability.

Referring to FIG. 4, at block 510a, document is parsed to locate one or more attributes. The parsing may include a determination of which attributes relate to various credit bureaus and/or include different logic for different credit-bureaus. At block 510b, the system 100 determines the credit bureau format(s) associated with the attribute. As described above, each credit bureau database 200a . . . 200n may include conventions specific to the credit bureau. Therefore, the format associated with an attribute helps determine which conventions to apply. Having determined the credit bureau format(s) associated with an attribute, the system 100 determines, at block 510c, the type codes associated with attributes at the respective credit bureau(s). Then, at block 510d, depending on the type code associated with the attribute, the system 100 may apply the credit bureau specific conventions to generate a formatted attribute at block 510e.

Once all of the parsed attributes in the document received are formatted according to the applicable rules, then the system 100 may generate one or more specification documents (refer to block 512 in FIG. 2) and/or generate the appropriate code sets (refer to block 514 in FIG. 2). In some embodiments, the standardized code created by the transformation module is used to derive one or more specific computer language codes. As described above, the specification document may be generic, or may be formatted according to the platforms at the client's system. Also, the generated code set may be in compileable or executable code including one or more of, for example: C code, SAS code, LUA code, EDL code or Fascode.

It is recognized that the system 100 may perform the blocks in FIG. 4 in parallel for all attributes, or it may perform the blocks in serial form, each time iterating for each attribute in the document.

### Sample Pseudo-Code

In one embodiment, the pseudo-code for the attributes can be created using one or more attribute templates.

### Filter Template

For example, a template for a filter may include the following:
Order—Specifies the coding order of the filter
Category—Designates the type of data to which the filter applies, such as, for example, trade data, inquiry data, public record data, and so forth
Sub-Category—Designates account type and status of the filter, and so forth.
Filter Name—Provides a name for the filter
Description—Provides a description of the filter
Logic—Provides the definition of the filter, which may be credit bureau specific and/or data source specific.
Filter Type—Describes the output type of the filter.
Initial Value—Provides the value the filter is initially assigned
Default Value—Provides the value the filter is assigned if a record is not qualified
Valid Value—Provides the range of valid output values, including or excluding default values
Length—Provides a maximum and/or minimum length of the output

It is recognized that the items above are just examples, and additional filter template values as well as templates may be used. It is also recognized that there may be a variety of filter types depending on the data being processed. Some examples of filter types include the following:
1/0—A true or false filter (for example, 1 is true and 0 is false).
$—A dollar amount in whole values
$.$$—A dollar amount with cents.
%—A percent in whole values.
%. %—A percent with one decimal value.
Years—Number of years.
Quarters—Number of quarters.
Months—Number of months.
Days—Number of days.
Alphabetic—An alphabetic format.
Numeric—A numeric format.
Alphanumeric—An alphanumeric format
Rank—Indication of delinquency status.
Grid—A string, such as for a payment profile

It is recognized that the items above are just examples, and additional filter types may be used.

As one example, the following provides a filter defined as an open credit card with a balance of $500 or more, which can be used for both CRA 1 and CRA 2.
Order—1st
Category—Trade data
Sub-Category—Account Type.
Filter Name—OPEN_CC_W_500_BAL
Description—Open credit card with a balance of $500 or more
Logic CRA 1—<LOGIC for CRA 1>.
Logic CRA 2—<LOGIC for CRA 2>.
Filter Type—1/0.
Initial Value—0.
Default Value—0.
Valid Value—0, 1.
Length—1

It is recognized that many different filters or other attributes can be used by the system.

### Attribute Template

For example, a template for an attribute may include the following:
Attribute Name—Provides a name for the attribute
Description—Provides a description of the attribute.
Attribute Logic—Provides the definition of the attribute, which may be credit bureau specific and/or data source specific
Capping Logic—Logic to cap the output value
Default Logic—Logic to assign default values if there are no qualified records
Computation—Method of calculation.
Units—Designates the unit of measure.
Operand1—Filters or attributes used in the computation
Operand2—Filters or attributes used in the computation.
Initial Value—Provides the value the attribute is initially assigned (if any)
Type—Describes the output type or format of the attribute.
Length—Provides a maximum and/or minimum length of the output.
Valid Value—Provides the range of valid output values, including or excluding default values
Default Value and Description—Provides a description for each default value

It is recognized that the items above are just examples, and additional attribute template values as well as templates may be used. In addition, one or more of the values from the filter template may be used in any attribute template. The attribute types may include one or more of the filter types listed above. It is also recognized that there may be a variety of computations that can be performed by the attribute. Some examples of computations include the following:
Count—Count of the qualifying records.
Avg—Average of Operand1
Max—Maximum value of Operand1.
Min—Minimum value of Operand1.
Range—Interval between the maximum and the minimum of Operand1.
Ratio—Sum(Operand1)/sum(Operand2).
Sum—Sum of Operand1 and Operand2.
Special—Use the logic in the attribute.
Final—Calculation to be performed after aggregations

It is recognized that the items above are just examples, and additional computations may be used.

As one example, the following provides pseudo-code for an attribute that designates the highest credit card balances.
Attribute Name—HIGH_RISK_CC
Description—Designates the highest credit card balance with a max of $10k.
Attribute Logic—<INSERT LOGIC>.
Capping Logic—IF>10000, RETURN 10000.
Default Logic—IF NO QUALIFIED RECORD, RETURN 99999.
Computation—Max.
Units—Dollars.
Operand1—CC_WITH_BALANCES.
Operand2—Null.
Initial Value—0.
Type—$.
Length—5
Valid Value—0 to 10000.
Default Value and Description—99999: No Qualified Record Found

It is recognized that many different attributes can be used by the system. In addition, the system 100 may be configured to recognize and process one or more attribute or filter templates.

### Sample Specification

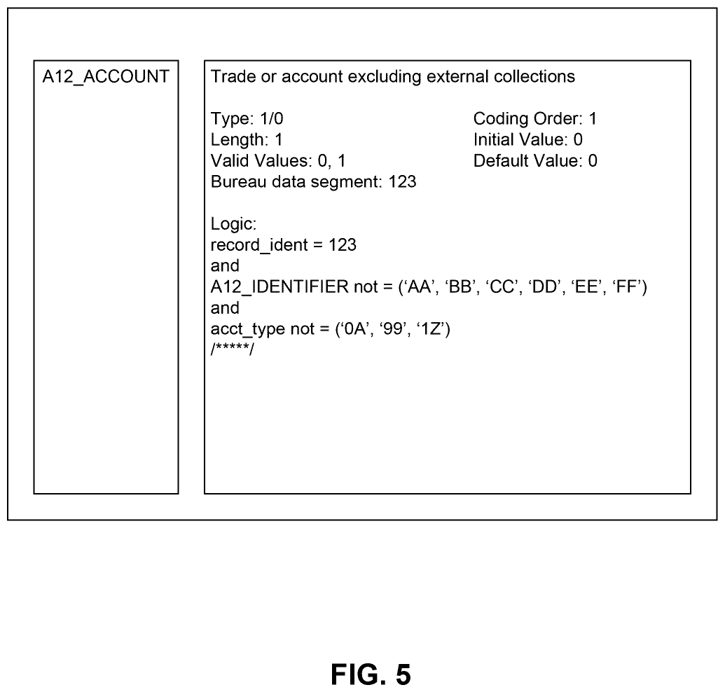

FIG. 5 is one embodiment of a sample automatically generated attribute specification. After receiving a document from a client, error checking, validating and formatting the document, the system 100 may automatically generate a specification which includes information for each attribute in the received document. The specification may include details for each attribute, such as description, type, coding order, length, initial value, default value, valid values, bureau data segment, and so forth. The attribute specification may also include logic associated with the attribute. In some embodiments, the specification is the same each different code set, whereas in other embodiments, the specifications may be specific to a particular code set. For example, there could be one attribute specification document for attributes A, B, and C which are all coded in SAS and Fascode, or there could be a separate attribute specification document for attributes A. B. and C for SAS and a separate attribute specification document for attributes A, B, and C for Fascode.

### Sample Code Set

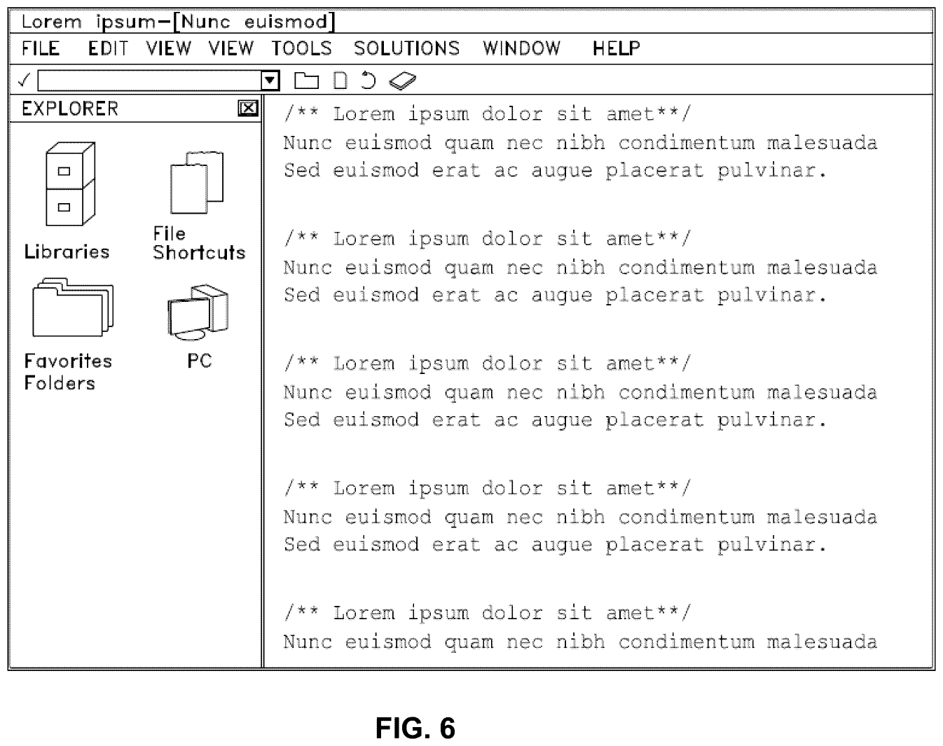

FIG. 6 is one embodiment of a screen display showing an example code set generated by the system 100. The example code set illustrated shows SAS executable code that corresponds to a document received, error checked, validated and formatted by the system 100. As noted above, a variety of languages can be used for code generation. The code may be compiled and/or executed by one or more systems of the client 300 that originally provided the spreadsheet or text document to the system 100. The generation of the specification and code sets is thus fully automated by the system 100, reducing the time and expertise needed by the client 300. As illustrated in FIG. 6, the code set generated may include both code and comments.

### Computing Systems

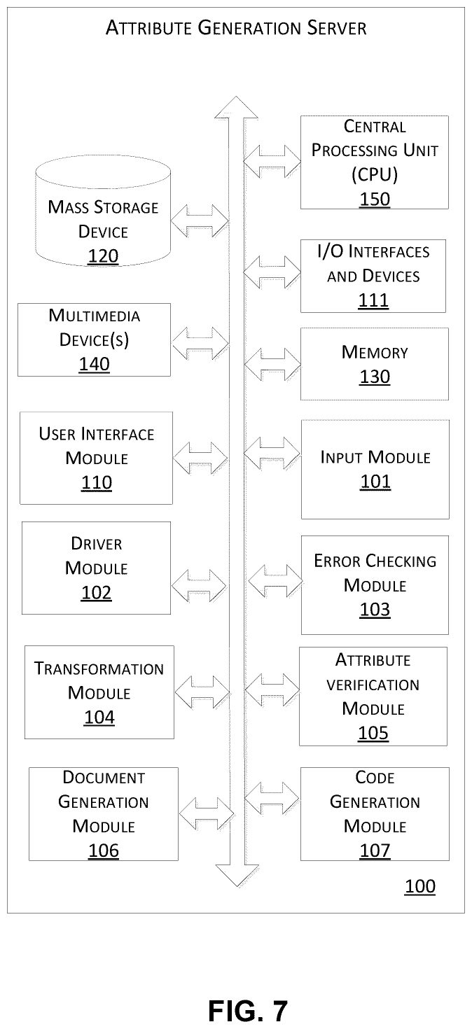

In some embodiments, the systems, computer clients and/or servers described herein take the form of a computing system as shown in FIG. 7. FIG. 7 is one embodiment of a block diagram of a computing system for automatically generating credit attribute specifications and/or code sets. The computing system 100 may be used to implement systems and methods described herein. For example, the computing system 100 may be configured to automatically generate attribute specification and/or code sets.

The computing system 100 includes, for example, a computer that is IBM, Macintosh or Linux/Unix compatible. In one embodiment, the computing system 100 comprises a desktop computer, a laptop computer, a server, or a server farm, for example. In one embodiment, the exemplary computing system 100 includes a central processing unit (CPU) 150, which may include a conventional microprocessor. The computing system 100 further includes a memory 130, such as random access memory (RAM) for temporary storage of information and a read only memory (ROM) for permanent storage of information, and a mass storage device 120, such as a hard drive, diskette, or optical media storage device. Typically, the modules of the computing system 100 are connected to the computer using a standard based bus system. In different embodiments, the standard based bus system could be Peripheral Component Interconnect (PCI), Microchannel, Small Computer System Interface (SCSI), Industrial Standard Architecture (ISA) and Extended ISA (EISA) architectures, for example. In addition, the functionality provided for in the components and modules of computing system 100 may be combined into fewer components and modules or further separated into additional components and modules.

The computing system 100 may be implemented in a component-based architecture with a high degree of flexibility, maintainability, and scalability. In one embodiment, multiple components can be hosted in a single environment and/or components can be distributed across a network with a load balancing server to manage and distribute requests among the components.

The computing system 100 is generally controlled and coordinated by operating system software, such as Windows 95, Windows 98, Windows NT, Windows 2000, Windows XP, Windows Vista, Windows 7, Windows 8, Unix, Linux, SunOS, Solaris, or other compatible operating systems. In Macintosh systems, the operating system may be any available operating system, such as MAC OS X. In other embodiments, the computing system 100 may be controlled by a proprietary operating system. Conventional operating systems control and schedule computer processes for execution, perform memory management, provide file system, networking, I/O services, and provide a user interface, such as a graphical user interface (GUI), among other things.

The computing system 100 includes one or more commonly available input/output (I/O) devices and interfaces 110, such as a keyboard, mouse, touchpad, touch sensitive screen, and printer. In one embodiment, the I/O devices and interfaces 110 include one or more display device, such as a monitor, that allows the visual presentation of data to a user. More particularly, a display device provides for the presentation of GUIs, application software data, and multimedia presentations, for example. The computing system 100 may also include one or more multimedia devices 140, such as speakers, video cards, graphics accelerators, and microphones, for example. In the embodiment of FIG. 7, the I/O devices and interfaces 110 provide a communication interface to various external devices.

In the embodiment of FIG. 7, the computing system 100 includes an input module 101, a driver module 102, an error checking module 103, a transformation module 104, an attribute verification module 105, a document generation module 106, and a code generation module 107. The computing system 100 is configured to execute the various modules 101, 102, 103, 104, 105, 106 and 107, among others, in order to receive a document describing various attributes in pseudo-code, perform various error checking and validation on the document to then automatically generate a specification and/or a code set for attributes.

The functionality provided for in the components and modules of the computing device(s) may comprise one or more components and/or modules. For example, the computing device(s) may comprise multiple central processing units (CPU) and one or more mass storage device(s), such as may be implemented in an array of servers.

In general, the word “module,” “application”, or “engine,” as used herein, refers to logic embodied in hardware and/or firmware, and/or to a collection of software instructions, possibly having entry and exit points, written in a programming language, such as, for example, Java, Ruby, Ruby on Rails, Lua, C and/or C++. A software module may be compiled and linked into an executable program, installed in a dynamic link library, or may be written in an interpreted programming language such as, for example, BASIC, Perl, or Python. It will be appreciated that software modules, applications, and engines may be callable from others and/or from themselves, and/or may be invoked in response to detected events or interrupts. Software instructions may be embedded in firmware, such as an EPROM.

It will be further appreciated that hardware may be comprised of connected logic units, such as gates and flip-flops, and/or may be comprised of programmable units, such as programmable gate arrays or processors. The modules, applications, and engines described herein are in certain applications implemented as software modules, but may be represented in hardware or firmware in other implementations. Generally, the modules, applications, and engines described herein refer to logical modules that may be combined with other modules and/or divided into sub-modules despite their physical organization or storage.

All of the processes described above may be embodied in, and fully automated via, software code modules executed by one or more general purpose computers. The code module may be stored in any type of computer-readable medium or other computer storage device. Some or all of the methods may alternatively be embodied in specialized computer hardware. As will be apparent, the features, and attributes of the specific embodiments disclosed above may be combined in different ways to form additional embodiments, all of which are fall within the scope of the present disclosure. Although this disclosure has been described in terms of certain embodiments and applications, other embodiments and applications that are apparent to those of ordinary skill in the art, including embodiments which do not provide all of the features and advantages set forth herein, are also within the scope of this disclosure.

Each of the processes, methods, and algorithms described in the preceding sections may be embodied in, and fully or partially automated by, code modules executed by one or more computer systems or computer processors comprising computer hardware. The methods may be executed on the computing devices in response to execution of software instructions or other executable code read from a tangible computer readable medium. A tangible computer readable medium is a data storage device that can store data that is readable by a computer system. The code modules may be stored on any type of non-transitory computer-readable medium or computer storage device, such as read-only memory, CD-ROMS, magnetic tape, flash drives, hard drives, solid state memory, optical disc, and/or the like. The systems and modules may also be transmitted as generated data signals (for example, as part of a carrier wave or other analog or digital propagated signal) on a variety of computer-readable transmission mediums, including wireless-based and wired/cable-based mediums, and may take a variety of forms (for example, as part of a single or multiplexed analog signal, or as multiple discrete digital packets or frames). The processes and algorithms may be implemented partially or wholly in application-specific circuitry. The results of the disclosed processes and process steps may be stored, persistently or otherwise, in any type of non-transitory computer storage such as, for example, volatile or non-volatile storage.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

In some embodiments, the computing device(s) communicates with one or more databases that store information, including credit data and/or non-credit data. This database or databases may be implemented using a relational database, such as SQLite, Sybase, Oracle, CodeBase, mySQL, and Microsoft® SQL Server as well as other types of databases such as, for example, a flat file database, an entity-relationship database, and object-oriented database, and/or a record-based database.

In one embodiment, the I/O devices and interfaces provide a communication interface to various external devices. For example, the computing device may be configured to communicate with one or more networks, such as any combination of one or more LANs, WANs, or the Internet, for example, via a wired, wireless, or combination of wired and wireless, communication links. The network communicates with various computing devices and/or other electronic devices via wired or wireless communication links.

It is recognized that the term “remote” may include data, objects, devices, components, and/or modules not stored locally, that is not accessible via the local bus. Thus, remote data may include a device which is physically stored in the same room and connected to the computing system via a network. In other situations, a remote device may also be located in a separate geographic area, such as, for example, in a different location, country, and so forth.

### Additional Embodiments

Although the foregoing invention has been described in terms of certain embodiments, other embodiments will be apparent to those of ordinary skill in the art from the disclosure herein. Moreover, the described embodiments have been presented by way of example only, and are not intended to limit the scope of the disclosure. Indeed, the novel methods and systems described herein may be embodied in a variety of other forms without departing from the spirit thereof. Accordingly, other combinations, omissions, substitutions and modifications will be apparent to the skilled artisan in view of the disclosure herein. For purposes of discussing the disclosure, certain aspects, advantages and novel features of the invention have been described herein. Of course, it is to be understood that not necessarily all such aspects, advantages or features will be embodied in any particular embodiment.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the systems and methods with which that terminology is associated.

1. (canceled)

2. A computer system for automated attribute specification generation, the system comprising:
an attribute specification generation server configured to communicate with a data store that stores attributes and specific rules associated with respective entities, the attribute specification generation server comprising one or more processors programmed to execute instructions that cause at least one processor of the one or more processors to:
receive from a user system a plurality of attributes;
retrieve from the data store conventions including the attribute and specific rules associated with the respective entities responsive to a format and type code associated with each attribute;
apply the conventions to each associated attribute of the plurality of attributes to generate a plurality of formatted attributes; and
generate an attribute specification based on the plurality of formatted attributes.

3. The computer system of claim 2, wherein the instructions further cause the at least one processor to generate at least one executable code set based on the plurality of formatted attributes.

4. The computer system of claim 2, wherein the instructions further cause the at least one processor to determine a format associated with each attribute of the plurality of attributes.

5. The computer system of claim 2, wherein the instructions further cause the at least one processor to determine a type code associated with each attribute of the plurality of attributes at the respective entities.

6. The computer system of claim 2, wherein the respective entities comprise respective credit bureaus, and the attributes and specific rules are associated with the respective credit bureaus.

7. The computer system of claim 2, wherein the attributes include filtering attributes.

8. The computer system of claim 2, wherein the instructions further cause the at least one processor to display, on a user interface, at least a portion of the attribute specification.

9. A computer-implemented method for automated attribute specification generation, the method comprising:
as implemented by an attribute specification generation server configured to communicate with a data store that stores attributes and specific rules associated with respective entities, the attribute specification generation server comprising one or more hardware processors and configured with specific computer-executable instructions,
receiving from a user system a plurality of attributes;
retrieving from the data store conventions including the attribute and specific rules associated with the respective entities responsive to a format and type code associated with each attribute;
applying the conventions to each associated attribute of the plurality of attributes to generate a plurality of formatted attributes; and
generating an attribute specification based on the plurality of formatted attributes.

10. The computer-implemented method of claim 9 further comprising generating at least one executable code set based on the plurality of formatted attributes.

11. The computer-implemented method of claim 9 further comprising determining a format associated with each attribute of the plurality of attributes.

12. The computer-implemented method of claim 9 further comprising determining a type code associated with each attribute of the plurality of attributes at the respective entities.

13. The computer-implemented method of claim 9, wherein the plurality of attributes received from the user system comprises pseudo-code.

14. The computer-implemented method of claim 9, wherein the respective entities comprise respective credit bureaus, and the attributes and specific rules are associated with the respective credit bureaus.

15. The computer-implemented method of claim 9 further comprising displaying on a user interface at least a portion of the attribute specification.

16. Non-transitory, computer-readable storage media storing computer-executable instructions that, when executed by an attribute specification generation server configured to communicate with a data store that stores attribute and specific rules associated with respective entities and comprising one or more hardware processors, configure the attribute specification generation server to perform operations comprising:
receiving, from a user system, a plurality of attributes;
retrieving from the data store conventions including the attributes and specific rules associated with the respective entities responsive to a format and type code associated with each attribute;
applying the conventions to each associated attribute of the plurality of attributes to generate a plurality of formatted attributes; and
generating an attribute specification based on the plurality of formatted attributes.

17. The non-transitory, computer-readable storage media of claim 16, wherein the attribute specification generation server is further configured to generate at least one executable code set based on the plurality of formatted attributes.

18. The non-transitory, computer-readable storage media of claim 16 wherein the attribute specification generation server is further configured to determine a format associated with each attribute of the plurality of attributes.

19. The non-transitory, computer-readable storage media of claim 16, wherein the respective entities comprise respective credit bureaus, and the attributes and specific rules are associated with the respective credit bureaus.

20. The non-transitory, computer-readable storage media of claim 16, wherein the attributes include filtering attributes.

21. The non-transitory, computer-readable storage media of claim 16, wherein the attribute specification generation server is further configured to display on a user interface at least a portion of the attribute specification.
